(19) United States
(12) Patent Application Publication
(10) Pub. No.: US 2021/0240979 A1
(43) Pub. Date: Aug. 5, 2021

(54) INFORMATION SYSTEM FOR SHIPPING PACKAGES

(71) Applicant: ThePeople.de GmbH, 74223 Flein (DE)

(72) Inventor: Markus KIRNER, Heilbronn (DE)

(21) Appl. No.: 17/268,814

(22) PCT Filed: Aug. 26, 2019
(86) PCT No.: PCT/DE2019/000227

§ 371 Date: Feb. 16, 2021

(30) Foreign Application Priority Data
Aug. 28, 2018 (DE) 10 2018 006 813.8

(51) Int. Cl. G06K 9/00; B65D 5/42; G06K 9/20

(52) U.S. Cl. CPC G06K 9/00577; B65D 2203/06; G06K 9/2054; B65D 5/4212

(57) ABSTRACT

A shipping package, such as an envelope or a shipping box, which has individual features that can be detected by a camera-based image detection recognition. The digital content assigned to the individual features can be detected and displayed using a mobile communication unit. In this way, it is possible to centrally specify the digital content.

### TECHNICAL AREA

The invention relates to packages for postal delivery, wherein the packages can be sent either as letters by letter mail delivery, as well as packages or parcels by package mail delivery.

### PRIOR ART

Mailing envelopes for postal delivery of texts, documents, brochures and printed materials are known. Mailing envelopes include envelopes for letters that are available commercially in different sizes, as well as mailing bags. The mailing envelopes are usually produced from sheet-like cut-outs. The cut-outs are stamped out from a band provided on a reel. Next, the cut-outs are folded and glued, so that the desired mailing envelopes are formed. The so-called sealing tab remains open until after the letter or contents to be mailed have been placed inside.

The sheet-like cut-out as well as the band provided on a reel is usually made of paper, which can be reinforced with a textile mesh depending on the application. The use of tear-resistant cut-outs for producing envelopes made of a plastic foil is also known, which can have a fibrous structure, as needed.

Shipping packages used for mailing parcels also include, aside from mailing bags, mailing boxes in various sizes. The mailing boxes can be bipartite in design and have a separate bottom part as well as a separate lid part. In this case, the lid part is put over the bottom part and fixed in this position, for example using adhesive tape. Moreover, single-part mailing boxes are also known in which the bottom part and lid part are produced from a common, one-piece cut-out.

The mailing boxes are generally made of cardboard or a cardboard-like material, such as corrugated cardboard or cardstock.

After the letter or mailing contents are placed inside, the envelopes or mailing boxes are sealed. Addressing can be done through an address window, by means of printing, by means of a sticker or by handwriting. Franking can be done by imprints or glued-on stamps.

The envelopes and mailing boxes can be printed partially or entirely—for example for advertising purposes.

A printed product, for example a post card, in which a code is present, is known from WO 2014/079569 A1. The code can be detected by a mobile communication device. Before sending the post card, the sender must become active and assign the corresponding content —for example audio, image or text files—to the code. The recipient can view and/or download this content using his mobile communication device after reading the code.

### PRESENTATION OF THE INVENTION

The invention now seeks to solve the problem of creating a shipping package for mailing by post in which texts, documents, brochures and other printed matter suitable for mailing can be assigned to the shipping package in digital form.

To solve this problem, a shipping package is proposed with individual features located on at least one side, which are readable by camera-based image detection.

The individual features can be, for example, a barcode or a QR code. A pattern or watermark already existing in the material of the shipping package can serve as an individual feature as well. The individual features can be applied to the material of the shipping package, for example via laser engraving, spray methods, embossing or by printing. Alternatively or in addition, the individual features can be implemented by particles or fibers embedded into the material of the shipping package. In the case of particles, this can be the case, for example, when using recycling paper; with fibers, especially when using grass, herb or flower paper. A combination of different individual features is fundamentally possible.

The individual features can result from random assignment or software-controlled distribution.

In the present invention, the individual features are provided centrally with the data to be conveyed. Therefore, the sender does not have to edit each shipping package individually and upload the respectively desired files and assign them to the individual features. Rather, the desired files are created and provided centrally first, then a corresponding individual feature is created that is already linked with the desired data. In this way, it is possible to link a plurality of shipping packages with the desired files in a software-controlled and central manner. This may be attractive for advertising or information mailings, for example. In this regard, identical files—for example an advertising flyer or a general information letter—can be supplemented with individual data, for example a personalized salutation. Use of the shipping package according to the invention is also possible for shipping companies with goods shipments.

If the individual features completely penetrate the material of the shipping packages, they can be differentially recognized on both sides.

The individual patterns readable for the camera-based image detection can be located on at least one of the outer sides and/or on the inside of the shipping package. The individual features can be arranged on the front side as well as on the back side of the shipping package.

The image detection can be done centrally during production and assignment of the digital content. Furthermore, the image detection and the assignment of the digital content can also be done by the sender via a mobile communication unit.

The material of the shipping packages can be, in particular, paper, cardboard as well as materials similar to paper or cardboard. Recycled materials—for example newspapers or used packages—as well as grass, herb and flower papers can be used. It is not mandatory to bleach the materials used, so that significantly less chlorine has to be used for the material of the shipping packages than before. This makes cost savings possible and moreover, the shipping packages are significantly more environmentally friendly. However, it would also be possible to produce the shipping packages from plastics or foils.

With an envelope designed in this manner, it is possible for the unfilled envelope to be sent by mail without texts, documents, brochures or other printed matter. The texts, printed to date, can be provided to the recipient digitally and can be expanded to include audio, images and video. Franking with corresponding postage and the recipient address can be assigned to the respective envelope digitally as well. The digital content assigned to the respective mailing envelope is read by the recipient with a mobile communication device and displayed upon the latter.

For example, a first part of the individual features can be read and detected by the shipping company, for example the postal service provider and/or parcel delivery service. This can be done in particular using a corresponding app on a smartphone, tablet or a similar receiver device as a mobile communication unit. In this way the shipping company could receive in particular the delivery address and also, if applicable, special characteristics of the delivery address—for example a previously agreed alternative place to leave the package. Sufficient franking of the shipping package could be transmitted this way to the shipping company as well. Furthermore, other special details regarding delivery—especially the type of delivery, such as registered mail or payment for the delivery or mailed goods by COD (cash on delivery)—can be provided to the shipping company via the individual features. Thereby it can be possible to forgo address adhesive labels or the like completely. In the case of parcels and other goods shipments, the goods package can become a shipping package without any additional packaging, so that previously required secondary packaging can be saved. In this case, the imprints existing on the package of the goods could already serve as individual features.

Another part of the individual features could only be detected and read by the recipient. Individual features, which are only readable by the recipient, can be the actual mailed items or documents enclosed with the actual mailed items. If the actual mailed items contain documents, these documents can be sent electronically as a file. However, if the actual mailed items are a product, which was purchased in an online shop for example, the bill of delivery and/or the invoice cannot be enclosed with the parcel in paper form, but rather as a file sent electronically by means of the individual features.

If the sender of the mailed package is a private person, payment for shipping can also be done via a corresponding app on the mobile communication device. The sender's information can also be digitally recorded and in this way sent electronically to the recipient and, if applicable, to the shipping company.

In the event of returns, at least some part of the individual features can be refilled, so that a new recipient address and also the new postage can be stored. This can be done, for example, by sending the bill of delivery not merely as an uneditable text file, but rather storing it as a sort of online form. In this case, the recipient could determine on the online form which items are to be returned and also record information about the reasons for the return.

Furthermore, affiliate marketing possibilities are enabled by the individual features.

Therefore, cost savings and environmental protection are achieved by reducing the materials for the documents, printing inks, stickers, stamps and transport weight.

Furthermore, a part of the individual features can also enable detection by a recycling company of the materials used for the shipping package. In this case, the respective materials used in the shipping package can be clearly identified, so that automatic sorting of the shipping packages and single-variety recycling is possible. Thereby even high-quality materials could be used for the shipping package according to the invention.

The price of the shipping package can also be read via the individual features, so that payment for the shipping packages can be simplified.

Further features relating to the individualization and digital filling-out of an envelope in accordance with the invention are disclosed herein.

It would also be fundamentally possible to provide packing and gift papers, in addition to shipping packages, with the above-described individual features.

### SHORT DESCRIPTION OF THE DRAWING

The invention is described in more detail below based on an exemplary embodiment shown in a drawing. They show:

FIG. 1 a top-down view of the front side of an envelope according to the invention,

FIG. 2 the back side of the envelope according to FIG. 1 with closed sealing region,

FIG. 3 the back side of an alternative envelope with opened sealing region,

FIG. 4 the user while reading the individual features of the envelope with a mobile communication unit.

### WAYS TO EXECUTE THE INVENTION

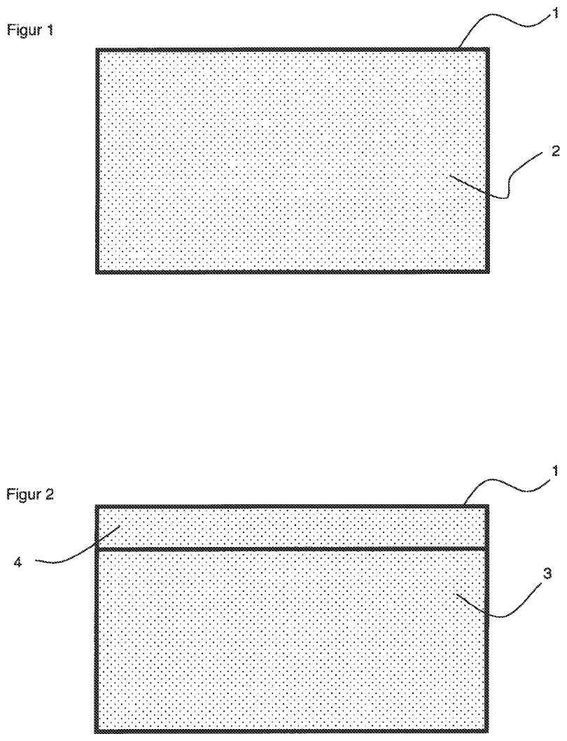

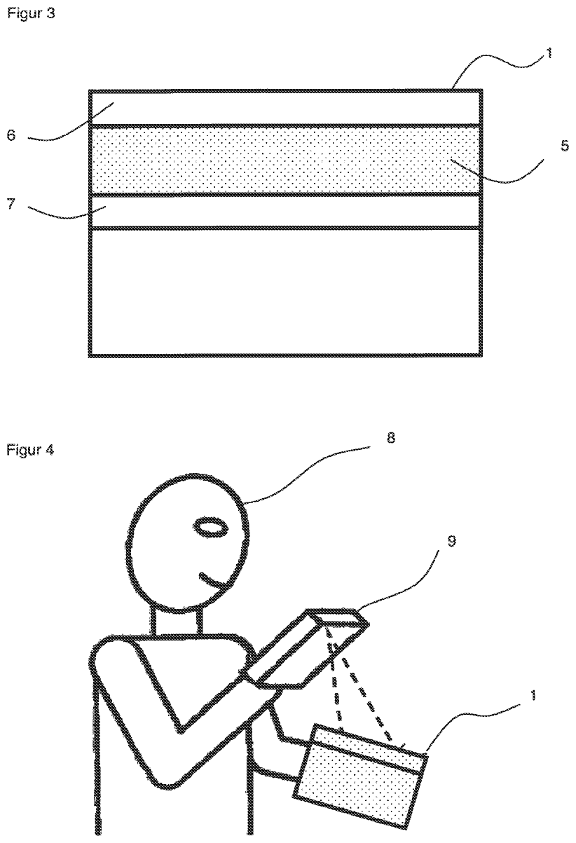

In FIGS. 1 to 3 of the drawings, the individually marked area of an envelope 1 is respectively shown, which latter was produced by folding and gluing from a cut-out of paper, fiber-reinforced paper, plastic or a composite material of paper and plastic. In this exemplary embodiment, the envelope 1 is composed of an individually marked front side 2 and back side 3 with a closed sealing flap 4. The sealing flap 4 seals the individually marked inner surface 5 of the envelope with the two sealing tabs 6 and 7.

According to the invention, in FIG. 4 of the drawings, the user 8 is shown while reading the individual features of an envelope 1 using a mobile communication unit 9.

1-11. (canceled)

12. A shipping package, comprising:
a) individual features detectable by a camera-based image detection; and
b) the individual features including assigned digital content detectable and displayable using a mobile communication unit.

13. The shipping package according to claim 12, wherein the shipping package includes outer sides and the individual features detectable by the camera-based image detection are located on at least one of the outer sides.

14. The shipping package according to claim 12, wherein the shipping package includes inner sides and the individual features detectable by the camera-based image detection are located on one of the inner sides.

15. The shipping package according to claim 12, wherein the shipping package includes a roll material or a cut-out and the individual features are previously applied to the roll material or the cut-out even before the shipping package is produced.

16. The shipping package according to claim 12, wherein the individual features are applied during production of the shipping package.

17. The shipping package according to claim 12, wherein the individual features are detectable during production of the shipping package.

18. The shipping package according to claim 12, wherein the assigned digital content is done centrally.

19. The shipping package according to claim 12, wherein the assigned digital content is detectable by a sender via a mobile communication unit.

20. The shipping package according to claim 12, wherein the individual features have multiple parts that are respectively intended for different groups of recipients, so that the multiple parts with respectively assigned digital content is only detectable for the respective groups of recipients.

21. The shipping package according to claim 20, wherein:
a) a first part of the individual features is intended for a shipping company;
b) the digital content of the first part of the individual features is detectable by the shipping company;
c) a second part of the individual features is intended for the recipient; and
d) the digital content of the second part of the individual features is detectable by the recipient.

22. The shipping package according to claim 20, wherein
a) a part of the individual features is intended for a recycling company; and
b) the digital content of the part of the individual features is detectable by the recycling company.
